(19) United States
(12) Patent Application Publication
(10) Pub. No.: US 2003/0133167 A1
(43) Pub. Date: Jul. 17, 2003

(54) Image processing method and apparatus

(75) Inventor: Jun Enomoto, Kanagawa (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/345,180

(22) Filed: Jan. 16, 2003

(30) Foreign Application Priority Data
Jan. 17, 2002 (JP) 2002-008585

(51) Int. Cl. B41J 1/00; G06F 15/00; H04N 1/23

(52) U.S. Cl. 358/302; 358/1.15

(57) ABSTRACT

The image processing method and apparatus photoelectrically capture an image photographed on a film to input an input image, subject the input image to image processing, store image processing information concerning the image processing performed on the input image and retrieval information for specifying the input image in association with each other, judge whether or not the image-captured film is a cut film, automatically perform retrieval using the retrieval information concerning the input image in accordance with a command specifying reprocessing when the film is judged as the cut film, and perform the reprocessing on the input image whose reprocessing has been commanded, using at least the retrieved image processing information.

### BACKGROUND OF THE INVENTION

1. Field of the Invention

The present invention relates to a technical field of a digital print system that first converts an image photographed on a film into digital image data and then reproduces it as a photographic print. In particular, the present invention relates to an image processing method and apparatus that, in such a digital print system, improves the efficiency of reprint processing and is capable of suitably outputting a reprint whose image is identical to an image of a print made on the occasion of film processing or an initial print.

2. Description of the Related Art

Heretofore, the images recorded on photographic films such as negative films and reversal films (which are hereinafter referred to simply as “films”) have been commonly printed on light-sensitive materials (photographic paper) by means of direct exposure in which the film image is projected onto the light-sensitive material to achieve its exposure.

A new technology has recently been introduced and this is a printer that relies upon digital exposure. Briefly, the image recorded on a film is read photoelectrically, converted to digital signals and subjected to various image processing schemes to produce image data for recording purposes; recording light modulated in accordance with the image data is used to scan and expose a light-sensitive material to record a latent image, which is subsequently developed to produce a finished print. The printer operating on this principle has been commercialized as a digital photoprinter.

The digital photoprinter basically includes: a scanner (image reading apparatus) that makes reading light incident on a film and reads projected light thereof, thereby photoelectrically reading an image recorded on the film; an image processing apparatus that performs predetermined processing on image data read with the scanner or the like to obtain image data for image recording (that is, exposure conditions); a printer (image recording apparatus) that scans and exposes a light-sensitive material by, for instance, performing light beam scan in accordance with the image data outputted from the image processing apparatus, thereby recording a latent image; and a processor (developing apparatus) that performs development processing on the light-sensitive material exposed by the printer so as to obtain a (finished) print in which the image is reproduced.

In such a digital photoprinter, images can be processed as digital image data to adjust images, so various operations including the correction of washed-out highlights and flat (dull) shadows due to the taking of pictures with rear light or an electronic flash, sharpening, and the like can be performed in an effective manner to produce prints of the high quality that has been unattainable by the conventional direct exposure.

Further, according to the digital photoprinter, images taken by a digital camera or the like can be outputted as prints.

Not only in the digital photoprinter described above but also in an analog photoprinter making use of direct exposure, so-called reprinting of an image photographed on a film is very often performed in which an image (frame) once printed is outputted again as a print in accordance with a request for extra printing or the like.

Note that, in the case of a photographic film that has conventionally been developed, with consideration given to convenience of storage or the like, the roll film is not returned to a customer as it is. In the case of a 135 film, for instance, this film is generally cut into pieces, with each piece containing four to six photographed frames. Then, these pieces are contained in a film container bag and are returned to a customer. In the case where the customer orders reprinting (extra printing), he/she usually brings the cut film cut into pieces and contained in this film container bag to a photo shop and makes the order.

At the photo shop, the film cut into pieces is taken out of the film container bag and an image of a designated frame is read with a scanner to produce a reprint. During this operation, if no specific correction is requested, it is required that an image reproduced on the reprint is identical to an image reproduced on a previously outputted print (in usual cases, a print outputted at the time of printing with film processing or initial printing). Therefore, in order to produce a reprint on which there is reproduced an image that is identical to the image reproduced at the time of printing with film processing or initial printing (which are hereinafter referred to generally as “initial printing”), the same image data is retrieved from image data stored in a database, image processing conditions used during the initial printing are extracted, and image processing is performed in accordance with the image processing conditions.

However, it is required to take the film cut into pieces out of the film container bag, to manually perform the retrieval, and to perform other processing. This complicated work frequently leads to a situation where differences in image color or density between the previous print and the reprint occur due to, for instance, different judgment and operation by an operator. This results in many complaints from customers.

Therefore, in order to cope with these problems, a print system which is capable of reordering without dealing with a film, is proposed in JP 09-55834 A and JP 09-179211 A, for instance.

Also, a print system that performs retrieval of image processing information with high efficiency is disclosed in JP 2000-222437 A, JP 2001-7965 A, and the like, for instance.

However, up to now, in the case where a reorder (reorder mode) is designated on an order form or the like or in the case where the initial number of printing is not set at zero but is set at one or more, for instance, an operator judges that reprinting should be performed. Then, in order to perform reprint processing under image processing conditions that are the same as those used during initial printing, he/she manually performs retrieval of the image processing conditions through key inputting operation as a trigger. This leads to a problem of extremely lowered work efficiency and impossibility of making a reprint coincident with a print made on the occasion of film processing or an initial print due to a misjudgment or the like.

### SUMMARY OF THE INVENTION

The present invention has been made in view of the conventional problems described above and an object of the present invention is to provide an image processing method which enables efficient retrieval particularly at the time of reprint processing and which can make a reprint coincident with a print made on the occasion of film processing or an initial print through a simple work.

Another object of the present invention is to provide an image processing apparatus to which the image processing method described above is applied.

In order to attain the above-mentioned objects, the first aspect of the present invention provides an image processing apparatus comprising:

image inputting means which photoelectrically captures an image photographed on a film to input an input image;

image processing means which subjects the input image inputted by the image inputting means to image processing to obtain a processed image;

storage means which stores image processing information concerning the image processing performed on the input image by the image processing means and retrieval information for specifying the input image in association with each other;

retrieval means which performs retrieval from the storage means using the retrieval information concerning the input image in accordance with a command that specifies reprocessing of the input image; and

film judging means which judges whether or not the image-captured film from which the image is captured by the image inputting means is a cut film cut into pieces,

wherein, when the film judging means judges that the image-captured film is the cut film, the retrieval means performs the retrieval automatically from the storage means, and wherein the image processing means performs the reprocessing on the input image to which the command for specifying the reprocessing is given, using at least the image processing information retrieved by the retrieval means.

Preferably, the storage means further stores at least one of image information concerning the input image processed by the image inputting means, a compressed image of the input image, and a compressed image of the processed image in association with the image processing information or the retrieval information, and wherein the retrieval means retrieves at least the image processing information from the storage means using at least one of image characteristic quantities of the input image, the image information, the compressed image of the input image and the compressed image of the processed image as the retrieval information.

And preferably, when the film judging means judges that the image-captured film is the cut film, the retrieval means automatically retrieves at least the image processing information from the storage means.

And preferably, the retrieval means is provided with a mode in which the retrieval is not performed if the film judging means judges that the image-captured film is not the cut film.

Preferably, the retrieval means is provided with an automatic retrieval mode which is previously selectable and in which the retrieval from the storage means is automatically performed even if the film judging means judges that the image-captured film is not the cut film.

And preferably, the automatic retrieval mode which is previously selectable is set in accordance with at least one of a type and a form of the film, wherein the film judging means can also judge whether or not the image-captured film is a previously set film, and wherein if the film judging means judges that the image-captured film is the previously set film, the retrieval means turns to the automatic retrieval mode to automatically retrieve from the storage means.

Further, in order to attain the above-mentioned objects, the second aspect of the present invention provides an image processing method with which an image photographed on a film is photoelectrically captured to input an input image, which is then processed to obtain a processed image, comprising the steps of:

storing image processing information concerning processing performed on the input image and retrieval information for specifying the input image in association with each other;

judging whether or not the image-captured film is a cut film cut into pieces;

automatically performing retrieval from the storage means using the retrieval information concerning the input image in accordance with a command specifying reprocessing of the input image when the image-captured film is judged as the cut film; and

performing the reprocessing on the input image whose reprocessing has been commanded, using the image processing information concerning the input image whose reprocessing has been commanded.

Preferably, the storage means further stores at least one of image information concerning the input image processed by the image inputting means, a compressed image of the input image, and a compressed image of the processed image in association with the image processing information or the retrieval information, and wherein at least the image processing information is retrieved from the storage means using at least one of image characteristic quantities of the input image, the image information, the compressed image of the input image and the compressed image of the processed image.

And preferably, when the image-captured film is judged as the cut film, at least the image processing information is automatically retrieved.

Preferably, when the image-captured film is not judged as the cut film, the retrieval is not performed.

And preferably, even in the case where the image-captured film is not judged as the cut film, the retrieval is automatically performed when previous selection is made for automatic retrieval.

Preferably, the previous selection is made in accordance with at least one of a type and a form of the film and if the image-captured film is judged as a previously set film, the automatic retrieval is performed.

### BRIEF DESCRIPTION OF THE DRAWINGS

FIG. 1 is a block diagram of an embodiment of a digital photoprinter that uses an image processing apparatus in which an image processing method of the present invention is implemented;

FIG. 2 is a block diagram showing an outline of the image processing apparatus of the embodiment under consideration; and

FIG. 3 is a flowchart showing the outline of the image processing method of the present invention.

### DETAILED DESCRIPTION OF THE PREFERRED EMBODIMENTS

The image processing method and apparatus of the present invention are now described in detail with reference to the preferred embodiment shown in accompanying drawings.

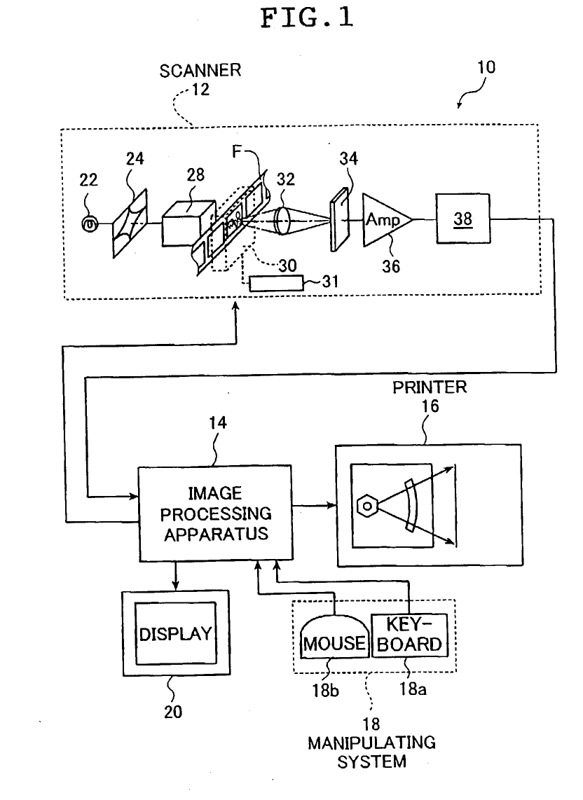

FIG. 1 is a block diagram showing an embodiment of a digital photoprinter that uses an image processing apparatus of the present invention in which an image processing method of the present invention is implemented.

The digital photoprinter 10 shown in FIG. 1 (hereinafter simply referred to as the “photoprinter 10”) basically includes: a scanner (image reading apparatus) 12 that photoelectrically reads an image photographed on a film F; an image processing apparatus 14 that performs image processing on the thus read image data and performs overall manipulation, control, and the like of the photoprinter 10; and a printer 16 that performs imagewise exposure of a light-sensitive material (photographic paper) with a light beam modulated in accordance with the image data outputted from the image processing apparatus 14 and performs development processing to output a (finished) print. Also, connected to the image processing apparatus 14 are a manipulating system 18 having a keyboard 18a and a mouse 18b for inputting or setting conditions, selecting and commanding processing, and entering a command and the like for effecting color/density correction, etc., as well as a display 20 for displaying the image captured with the scanner 12, various kinds of manipulative commands, and screens and the like for setting/registering conditions.

The scanner 12 is an apparatus (image inputting means) with which the images recorded on the film F or the like are read photoelectrically frame by frame. It comprises a light source 22, a variable diaphragm 24, a diffuser box 28 which diffuses the reading light incident on the film F so that it becomes uniform across the plane of the film F, an imaging lens unit 32, an image sensor 34 having line CCD sensors capable of reading R (red), G (green) and B (blue) images, an amplifier (Amp) 36 and an A/D (analog/digital) converter 38.

In the photoprinter 10, dedicated carriers 30 are available that can be loaded into the body of the scanner 12 in accordance with the type or the size of the film used (e.g. a negative film of 135 size or Brownie size, or an APS film). By interchanging carriers 30, the photoprinter 10 can be adapted to process various kinds of films in various modes. The images that are recorded on respective frames of the film and which are subjected to the necessary procedure for print production are transported to and held in a specified reading position by means of the carriers 30.

The scanner 12 captures the images recorded on the film F in the following manner; the reading light from the light source 22 has its quantity adjusted by means of the variable diaphragm 24 and is incident on the film F held in the specified reading position by means of the carrier 30 and thereafter passes through the film F to produce projected light bearing the image recorded on the film F.

The reading light passes through the film F held on the carrier 30 and the resulting image bearing, projected light is focused by the imaging lens unit 32 to form a sharp image on the light-receiving plane of the image sensor 34. The scanner may be of a type that relies upon the slit scan technique, or of a type that relies upon the planar exposure technique by which the image in one frame is scanned across at a time.

The output signals from the image sensor 34 are amplified with the amplifier 36, converted to digital form in A/D converter 38 and sent to the image processing apparatus 14.

Also, in the present invention, the carrier 30 is provided with a film judging section 31 that, when a film is inserted into the carrier 30, judges whether or not the image-captured film F from which the image is captured by the carrier 30 is a film cut into several pieces with reference to the length of the transported film, the number of images (frames) read from the film, or the like. A judgment signal (judgment result) is sent from the film judging section 31 to the image processing apparatus 14.

The film judging section 31 is not limited to the one judging whether or not the image-captured film F is a film cut into pieces (cut film) but may judge whether or not the image-captured film F is a long rolled film such as a usual roll film contained in a cartridge (e.g., 12-, 24- or 36-exposure 135 film or 25- or 40-exposure APS film), or a film formed by splicing several rolls of film.

In the scanner 12, the images recorded on the film F are captured by two scans, the first being prescan at low resolution and the second being fine scan for obtaining output image data.

Prescan is performed under preset prescan reading conditions that ensure that the images on all films to be handled by the scanner 12 can be read without saturating the image sensor 34. Fine scan uses the prescanned data and is performed under fine scan reading conditions that are set for each frame such that the image sensor 34 is saturated at a slightly lower density than the minimum density of the image (frame) of interest. Therefore, the output signals for prescan and fine scan have different resolutions and output levels even if they are essentially the same image.

As described above, the output signal (image data) from the scanner 12 is outputted to the image processing apparatus 14.

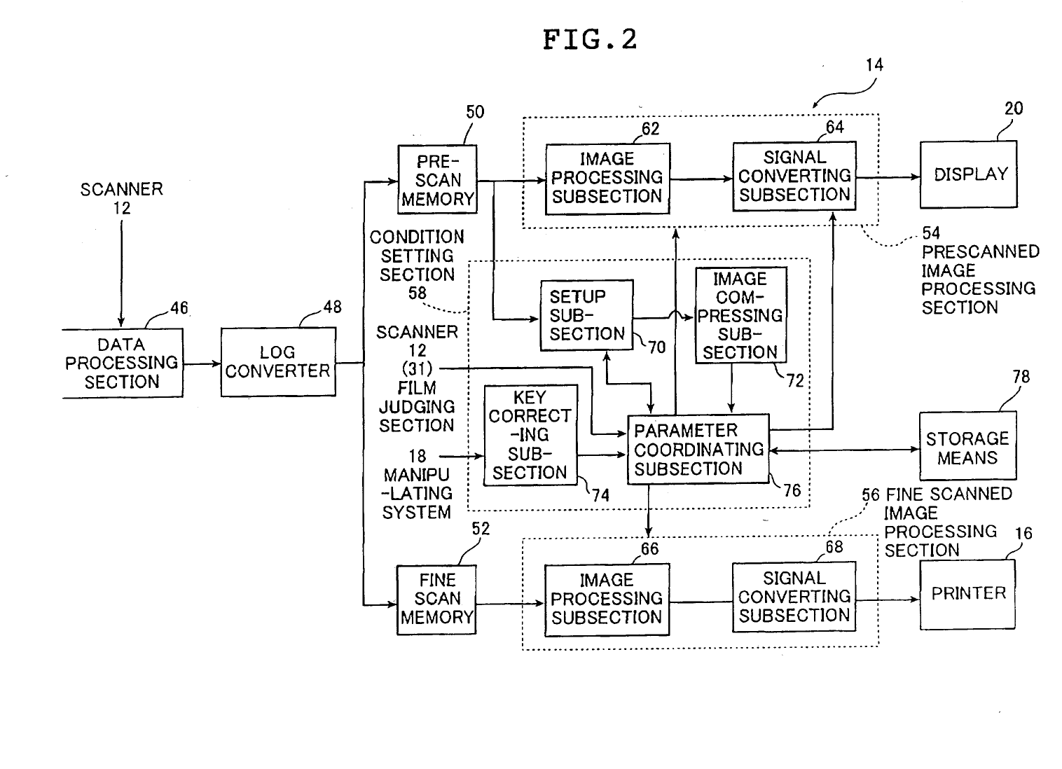

FIG. 2 is a block diagram showing the image processing apparatus 14. As shown in FIG. 2, the image processing apparatus 14 (hereinafter referred to as “processing apparatus 14”) comprises a data processing section 46, a log converter 48, a prescan (frame) memory 50, a fine scan (frame) memory 52, a prescanned image processing section 54, a fine scanned image processing section 56, and a condition setting section 58.

FIG. 2 shows only the sites related to image processing and besides these sites, the image processing apparatus 14 includes a CPU for controlling and managing the overall operation of the photoprinter 10 including the image processing apparatus 14, memories for storing the information necessary for the operation and otherwise of the photoprinter 10, means for determining the stop-down value of the variable diaphragm 24 and the accumulating time of the CCD sensor 34, and the like. The manipulating unit 18 and the display 20 are connected to related sites via the CPU and the like (CPU bus).

The R, G and B output signals outputted from the scanner 12 are sent to the data processing section 46, where they are subjected to specified processing steps such as DC offset correction, dark current correction, and shading correction. Thereafter, the processed digital signals are transferred into the log converter 48, where they are converted to digital form, of which prescanned (image) data is stored in the prescan memory 50 and fine scanned (image) data is stored in the fine scan memory 52.

It should be noted here that in the case where a print is produced using image data supplied from an image data supply source other than the scanner 12 (such as a digital camera), the data processing section 46 converts the data into image data that can be processed by the photoprinter 10 (image processing apparatus 14), for instance.

The prescanned data stored in the prescan memory 50 is read into the prescanned image processing section 54, which then processes the data. On the other hand, the fine scanned data stored in the fine scan memory 52 is read into the fine scanned image processing section 56, which then processes the data.

Here, the prescanned image processing section 54 includes an image processing subsection 62 and a signal converting subsection 64. On the other hand, the fine scanned image processing section 56 includes an image processing subsection 66 and a signal converting subsection 68.

The image processing subsection 62 (hereinafter referred to as the processing subsection 62) in the prescanned image processing section 54 and the image processing subsection 66 (hereinafter referred to as the processing subsection 66) in the fine scanned image processing section 56 are both the sites (image processing means) where the image (image data) captured with the scanner 12 is subjected to image processing in accordance with the conditions that are set by means of the condition setting section 58 to be described below in this specification. The processing subsections 62 and 66 basically perform the same processing except that the image data to be processed have different pixel densities.

The image processing performed in the two processing subsections 62 and 66 is at least one of known various kinds of image processing exemplified by gray balance adjustment, gradation adjustment, density adjustment, geometric distortion correction, correction of marginal luminosity, sharpness (sharpening) processing, dodging processing, electronic scaling processing, special finishing such as soft-focus finishing or black-and-white finishing, red-eye correction, and the like.

These corrections need only be made by known methods comprising appropriate combinations of arithmetic operations, processing with LUTs (look-up tables), matrix (MTX) operations, processing with low-pass filters (LPFs), and the like.

As an example, the gray balance adjustment, density adjustment, and gradation adjustment are all performed with a method that uses LUTs created in accordance with image characteristic quantities. Note that these correction tables are usually created for each color of R, G, and B.

By way of example, saturation adjustment is performed with a method that uses MTX operations.

In an exemplary method for the sharpness processing, an image is divided into frequency components, luminance signals obtained from middle and high frequency components are multiplied by a sharpness gain (sharpness enhancing (correction) coefficient), and luminance information obtained as a result of these operations is added to a low frequency component.

The signal converting subsection 64 in the prescanned image processing section 54 is a site where the image data processed by the processing subsection 62 is converted with a 3D (three-dimensional)-LUT or the like into image data that can be displayed on the display 20.

On the other hand, the signal converting subsection 68 in the fine scanned image processing section 56 is a site where the image data processed by the processing subsection 66 is converted with a 3D-LUT or the like into image data that is subsequently supplied into the printer 16 as image data for image recording by the printer 16. The printer 16 scans and exposes a light-sensitive material (photographic paper) with a light beam modulated in accordance with the supplied image data, thereby forming a latent image. The printer 16 then subjects the latent image to predetermined development processing and outputs it as a print.

The conditions for the processing to be carried out in the two converting subsections 64 and 68 are set in the condition setting section 58.

The image processing to be carried out in the prescanned image processing section 54 and the fine scanned image processing section 56 and conditions for the image processing are set by the condition setting section 58.

This condition setting section 58 includes a setup subsection 70, an image compressing subsection 72, a key correcting subsection 74, and a parameter coordinating subsection 76. Also, connected to the parameter coordinating subsection 76 is a storage means 78 for storing image processing information used to process an image in a frame when a print has previously been produced therefrom, in association with retrieval information for specifying the image of this frame. In this example, the storage means 78 also functions as a database. In addition to the image processing information and the retrieval information on the frame of interest, the storage means 78 may also store at least one of image information of the processed image of this frame (input image) and images such as a compressed image of the image of the frame to be processed and a compressed image of the processed image of the frame, in association with the image processing information or the retrieval information on the frame of interest.

It should be noted here that in usual cases, the storage of the image processing information and the retrieval information described above into the storage means 78 during print production is performed at the time of printing with film processing or initial printing (which are hereinafter referred to generally as “initial printing”). Therefore, in the following description, it is assumed that printing that involves the storing operation is initial printing and printing that does not involve the storing operation is reprinting.

The setup subsection 70 sets image processing to be carried out in the prescanned image processing section 54 and the fine scanned image processing section 56.

More specifically, in the case of initial printing, the setup subsection 70 reads prescanned data and uses it to perform various processing including the construction of density histograms, the calculation of various image characteristic quantities, and the extraction of principal portions. Here, the calculated image characteristic quantities include predetermined % points of frequencies (such as an average density, highlights (minimum density), and shadows (maximum density)) in the density histograms, LATDs (large-area-transmission densities), and densities with the maximum values and densities with the minimum values in the histograms. The setup subsection 70 then sets reading conditions for fine scan in the manner described above and sets image processing in accordance with the density histograms, image characteristic quantities, commands from an operator, and the like. That is, the setup subsection 70 determines image processing to be carried out, the order of the image processing, and image processing conditions for each image processing, and supplies them to the parameter coordinating subsection 76.

On the other hand, in the case of reprinting, like in the case of initial printing, the setup subsection 70 sets reading conditions for fine scan by performing the construction of density histograms and the calculation of image characteristic quantities. In addition, the setup subsection 70 determines the image processing operations to be carried out, the order of the image processing operations, and conditions for the image processing using image processing information used during initial printing of a target frame that has been read from the storage means 78 by the parameter coordinating subsection 76. By doing so, the image processing during the initial printing is basically reproduced. The setup subsection 70 then supplies them to the parameter coordinating subsection 76.

It should be noted here that in the case where print conditions and the like for reprinting differ from those for the initial printing, the image processing conditions and the like for the reprinting may be changed as required. When different conditions concerning image fine structures are used like in the case where different print size and resolution are used, for instance, it is preferable that image processing conditions concerning the image fine structures (intensities of the sharpness processing, graininess suppressing processing, and the like, for instance) are changed accordingly.

It should be noted here that in either case of initial printing and reprinting, the setup subsection 70 is not limited to a construction where the image processing conditions are set only from image data in a frame whose print should be produced. For instance, the setup subsection 70 may set the image processing conditions additionally using image data in every frame of one roll of film or image data in a plurality of frames that have already been processed.

The key correcting subsection 74 calculates respective correction amounts in accordance with image correction commands entered by an operator using the keyboard 18a or the mouse 18b of the manipulating system 18 for color correction, density correction, contrast (gradation) correction, and the like The key correcting subsection 74 then supplies the calculated correction amounts to the parameter coordinating subsection 76.

After receiving the image processing conditions and the like set by the setup subsection 70, the parameter coordinating subsection 76 sets the supplied image processing conditions and the like at predetermined sites of the prescanned image processing section 54 and the fine scanned image processing section 56. Also, in accordance with the correction amounts and the like calculated by the key correcting subsection 74, the parameter coordinating subsection 76 sets processing conditions (such as a LUT) for carrying out this correction, sets the processing conditions at predetermined sites of the prescanned image processing section 54 and the fine scanned image processing section 56, and adjusts the image processing conditions that have been set beforehand.

Also, in the case of initial printing, after the image processing has been established, the parameter coordinating subsection 76 sends to the storage means 78 image processing information used to process an image of a frame and retrieval information, optionally together with image information of the captured and processed image, a processed image and/or an image to be processed. The storage means 78 may store a compressed image obtained by compressing the image to be processed or the processed image in the image compressing subsection 72, in association with the image processing information or the retrieval information on this frame.

On the other hand, in the case of reprinting, the parameter coordinating subsection 76 retrieves image processing information or the like from the storage means 78 by using for the retrieval information image data of an image in a frame that should be reprinted, and image characteristic quantities (for a common film such as a 135 film), or image information including an FID (film ID) and a frame number (for an APS film). The retrieved image processing information or the like is supplied to the setup subsection 70.

Also, in the case where the storage means 78 stores a compressed image obtained by compressing the image of the frame, it is preferable that the parameter coordinating subsection 76 performs retrieval using this compressed image (image data) or the retrieval information, ranks images (candidate images) having a high matching degree among the compressed images stored in the storage means 78, reads out the candidate images up to a predetermined ranking as necessary and displays them on the display 20 as the compressed images or after expansion so that an operator can confirm the retrieval result.

Basically, the method of the present invention first judges whether or not the image-captured film F from which the image is captured by the scanner 12 is a film cut into several pieces, and in the case of a film cut into pieces as a result of this judgment, it is deemed that reprinting is currently being performed, so that the retrieval is automatically performed and reprocessing is performed using retrieved image processing information used at the time of initial printing.

In this process, if the result of this judgment shows that the image-captured film F is not a film cut into pieces, it is preferred that the retrieval is not performed based on the determination that initial printing is currently being performed.

Even in the case where the image-captured film F is not judged as a film cut into pieces, the retrieval may be automatically performed if the automatic retrieval is previously selected. To be more specific, when setting is previously made for selecting that the automatic retrieval should be performed in an APS film, if the image-captured film is judged as an APS film previously set, the automatic retrieval can be performed even in a long rolled film.

The setting is previously made for selecting that the automatic retrieval should be performed, in accordance with at least one of the type and form of the film F, for example with respect to the film type such as a roll film (long rolled film) including the APS film described above, and if the image-captured film F is judged as a previously set film, the automatic retrieval can be performed.

To be more specific, the film judging section 31 provided for the carrier 30 judges whether or not the film F is a film cut into pieces during image reading, and a result of this judgment is sent to the parameter coordinating subsection 76 of the image processing apparatus 14. The parameter coordinating subsection 76 performs the automatic retrieval if the judgment result shows that the film F is a film cut into pieces. If the judgment result shows that the image-captured film F is not a film cut into pieces to the contrary, the retrieval is preferably not performed.

Note that setting is preferably made to make selectable whether or not the retrieval operation is to be performed automatically. In other words, it is preferable to set automatic retrieval activation mode and automatic retrieval deactivation mode so that one of them can be selected. For example, an APS film that is a roll film (long rolled film) is always not judged as a film cut into pieces and therefore the retrieval is not performed. However, the retrieval may be performed even in this case. If the retrieval is to be automatically performed in the case of an APS film, when a film is inserted, its FID is automatically read and the retrieval is automatically performed using this FID in combination with a frame number. In this case however, the film judging section 31 can of course judge whether or not the film F is an APS film.

Previous setting for selecting whether or not the retrieval operation is to be performed automatically is made in accordance with at least one of the type and form of the film F, for example with respect to the film type such as a roll film (long rolled film) including an APS film as described above, and if the film judging section 31 judges that the image-captured film F is a previously set film, the parameter coordinating subsection 76 can perform the automatic retrieval.

The image compressing subsection 72 receives prescanned data from the setup subsection 70 at the time of initial printing (and at the time of reprinting as necessary), compresses image data (hereinafter also simply referred to as the “image”) of a corresponding image, and supplies it to the parameter coordinating subsection 76. The parameter coordinating subsection 76 performs the retrieval using the image data (compressed image data), image characteristic quantity data, or information such as an FID.

A method of compressing image data, which is applied to a method of generating a compressed image for retrieval is not specially limited, and it is possible to use various known methods for image compression such as JPEG.

The compressed image generated by the image compressing subsection 72 is preferably stored in the storage means 78 together with image processing information or retrieval information concerning the frame of interest associated by the parameter coordinating subsection 76.

It should be noted here that in this embodiment, the storage means 78 functioning as a database stores image processing information when an image of a frame was processed and retrieval information for specifying the image of the frame in association with each other, optionally together with image information concerning the processed image of this frame and a compressed image of the processed image or the image to be processed, in association with the image processing information or the retrieval information. However, the present invention is not limited to this. That is, the database (storage means) for storing the image processing information and the database (storage means) for storing the retrieval information, image information or compressed image may be constructed as different databases so long as these databases are associated with each other. Also, it is not required that image data itself is stored. When an image or a compressed image is stored, the image or the compressed image is preferably displayed on the display 20 after the retrieval so that an operator can confirm it. In fact, when consideration is given to the efficiency of the retrieval and a storage capacity, it is further preferable that the images themselves are basically not stored for keeping processing speed and reducing the volume but the retrieval is performed using the image characteristic quantities (in a common film) or the retrieval information such as an FID and a frame number (in an APS film).

Here, the image processing information refers to information with which the image processing performed during initial printing is reproduced during reprinting of the same image, and for instance, includes the kinds of image processing carried out, the order of the image processing, image processing conditions (including parameters and related data), and the like.

The image processing conditions include various kinds of information with which it is possible to reproduce previous image processing (conditions) in accordance with image processing to be carried out on input images (data). More specifically, the image processing conditions include LUTs created to perform image processing, expressions for arithmetic operations, predetermined coefficients for image processing, and the like.

For instance, LUTs are stored in the case of image processing such as gray balance adjustment performed using LUTs. Also, MTX operation expressions are stored in the case of image processing such as saturation correction performed through MTX operations. For sharpness processing, sharpness gains (sharpness enhancing coefficients) are stored. In the case of dodging processing, LUTs or arithmetic operations are set to process image data and the image data obtained through the processing is used to compress a dynamic range, so that these LUTs or arithmetic operations are stored.

In the case where an operator inputs for correction using for example DCMY keys as a result of verification or the like and the image processing conditions are changed accordingly, the changed image processing conditions are stored. In this case, the original conditions are also stored.

Also, in the case where an operator inputs for correction as a result of verification or the like and new processing conditions like LUTs are set accordingly in the manner described above and are incorporated, these processing conditions and their order (positions at which the conditions are incorporated) are preferably contained in the image processing information.

It should be noted here that in the case where LUTs, function expressions, or the like are created for respective colors of R, G, and B, all of them are stored.

Various other conditions such as interior setup conditions and finishing conditions for monochrome finishing or sepia-tone finishing are preferably also contained in the image processing information.

The retrieval information is information such as data for specifying an image of a frame which was processed using image processing information stored in the database (storage means 78 or the like) and is stored in association with image processing information of the processed image of the frame. The retrieval information includes image characteristic quantities (data) concerning the image of the frame and compressed images (data) (in a common film such as a 135 film or a Brownie) and image information such as an FID, a frame number and a film type (in an APS film).

In addition, the image information of the image of the frame may be used as the auxiliary retrieval information for the main retrieval information such as the image characteristic quantities, compressed images, FID, frame number and film type.

The image information concerning the image subjected to image processing is stored in the storage means 78 as required together with the image processing information, and examples of the image information include a frame number of the image, an FID (film ID) and a film type used as the retrieval information. However, a camera model, a customer ID, a proper image ID, date and time (date, month and year) of the acceptance of a print order, an ID of a store accepting the print order, an equipment ID, an order, a film format (ASP, 135, Brownie and the like), a film carrier type, a film mask, photographing date and time (time, date, month and year), an image format (BMP, JPEG and the like), and an ordering terminal ID may also be used for the image information which can be used as the auxiliary retrieval information.

The storage means 78 for storing the image processing information and the retrieval information, optionally together with image information and/or (compressed) image data is not specially limited and it is possible to use various kinds of means.

In the case where a photofinisher (photo shop) creates a customer database, for instance, this database is used as the storage means 78. Note that, if the information is permanently stored, it is required to store an enormous amount of information, so that the information may be stored for a fixed time period that has been determined as appropriate. For instance, a request of reprinting is usually made within one month from initial printing, so that the storage time period need only be set at around one month from the initial printing.

Also, a recording medium such as a flexible disk, a magneto-optical recording medium or an IC card may be used as the storage means 78. In this case, the recording medium is handed to a customer along with prints, and the customer provides this recording medium along with the film F when he/she requests reprinting. The recording medium is read by a drive or the like connected to the photoprinter 10.

Alternatively, the storage means 78, and the processing apparatus 14 or a personal computer possessed by a photofinisher may be connected to a communication means such as a computer communication network like a LAN or WAN (Wide Area Network) to access for storage or retrieval of retrieval information, image processing information and the like.

In this case, retrieval information concerning each frame and its image processing information may be collectively managed using a center scheme. Also, when a request for reprinting of the film F is received, image processing information or the like may be obtained by accessing a database at another photofinisher that carried out initial printing. Further, retrieval information and image processing information may be stored at the time of initial printing or the like by using a personal computer possessed by a customer as the storage means 78 and the image processing information and the like may be obtained by accessing the personal computer at the time of reprinting.

As described above, image data processed in the prescanned image processing section 54 of the processing apparatus 14 is sent to the display 20, while image data processed in the fine scanned image processing section 56 is sent to the printer 16.

The printer 16 includes a printer (printing apparatus) that records a latent image by exposing a light-sensitive material (photographic paper) in accordance with the supplied image data and a processor (developing apparatus) that carries out predetermined processing on the exposed light-sensitive material and outputs it as a print.

To give one example, after the light-sensitive material is cut into a predetermined length in accordance with the size of the final print, the printer 16 records a back-print; next, the printer 16 modulates three kinds of light beams for R exposure, G exposure, and B exposure corresponding to the spectral sensitivity characteristics of the light-sensitive material in accordance with the image data outputted from the processing apparatus 14 and deflects the modulated light beams in the main scanning direction; in addition, the printer 16 transports the light-sensitive material in the auxiliary scanning direction orthogonal to the main scanning direction; as a result, the printer 16 records a latent image by two-dimensionally scanning and exposing the light-sensitive material with the light beams and supplies the latent image to the processor; after receiving the light-sensitive material, the processor performs predetermined wet development processing (such as color forming development, bleach-fixing, and rinsing), dries the light-sensitive material to obtain a print; a plurality of prints thus produced are sorted and stacked in a predetermined unit as for each roll of film.

The image processing method and apparatus of the present invention will now be described in more detail by explaining the operation of the photoprinter 10.

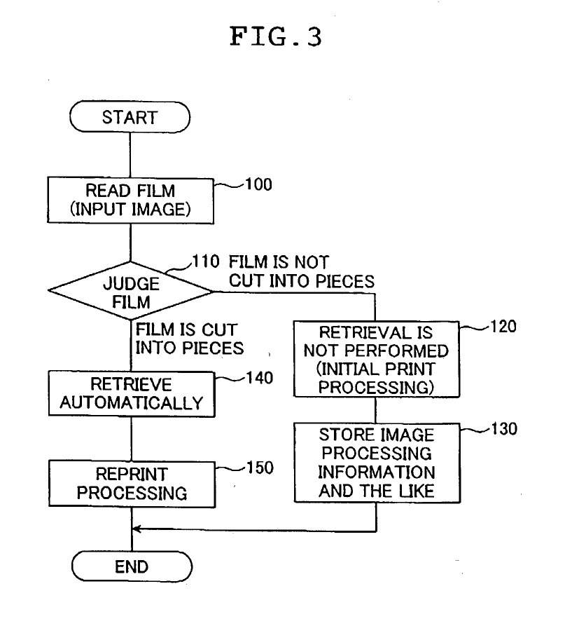

In FIG. 3, there is shown a schematic flowchart of an image processing method of the present invention.

First, in step 100, an operator requested to produce prints of the film F loads the scanner 12 with a carrier 30 corresponding to the film F at a predetermined position, sets the film F at a predetermined position of the carrier 30, and inputs images from the film F with the scanner 12.

That is, the stop-down value of the variable diaphragm 24 of the scanner 12 and the accumulating time of the image sensor (line CCD sensor) 34 are set in accordance with the reading conditions for prescan. Following this, the carrier 30 transports the film F in the auxiliary scanning direction at a speed corresponding to the prescan and the prescan is started. As described above, the film F is slit-scanned at a predetermined reading position, projected light is focused on the image sensor 34, and the image photographed on the film F is dissolved into R, G, and B components and is photoelectrically captured.

An output from the image sensor 34 is amplified by the amplifier 36 and is converted into a digital signal by the A/D converter 38. The digital signal is sent to the processing apparatus 14, after which it is given predetermined processing such as offset correction in the data processing section 46 and converted to digital image data in the log converter 48, with the image data being then stored in the prescan memory 50.

When prescanned data is stored in the prescan memory 50, the setup subsection 70 reads out the data, and performs the construction of density histograms and calculation of image characteristic quantities. Based on the results obtained, the setup subsection 70 sets reading conditions for fine scan such as the stop-down value of the variable diaphragm 24, and sends the set reading conditions to the scanner 12. The setup subsection 70 also sends the prescanned data to the image compressing subsection 72. The setup subsection 70 sends the image characteristic quantities to the parameter coordinating subsection 76 as the retrieval information but may directly send them to the storage means 78 for use as a database.

Next, in step 110, the film judging section 31 judges whether or not the film F from which the image is captured by the scanner 12 is a film cut into pieces. As described above, for instance, as for this judgment, there may be counted the number of images (number of frames) captured during the transporting of the film F with the carrier 30 and, if the number of the frames is not more than four or six for instance, the film judging section 31 may judge that the film F is a film cut into pieces. Alternatively, the film judging section 31 may make the judgment with reference to the length of the film F. This is because initial printing is usually performed using a film that is not yet cut after development and the film remains in the form of a long rolled film (roll film), so that it is conceived that there occurs no problem even if the judgment as to whether or not the film F is a film cut into pieces is made with reference to the length.

In the case where it has not been judged that the film F is a film cut into pieces in step 110, it is judged that initial printing is currently being performed. Therefore, the processing proceeds to step 120 in which retrieval is not performed and ordinary initial print processing is performed.

That is, the setup subsection 70 selects image processing operations that should be carried out for frames (images) of the film F in accordance with the density histograms, image characteristic quantities, and commands from the operator. The setup subsection 70 then determines the order of the image processing operations and sets (calculates) image processing conditions for the respective image processing operations.

The set image processing conditions are sent to the parameter coordinating subsection 76 and are set at predetermined positions (hardware) of the prescanned image processing section 54 and the fine scanned image processing section 56 by the parameter coordinating subsection 76.

The prescanned data sent from the setup subsection 70 to the image compressing subsection 72 is compressed to obtain compressed images. Then, the compressed images are sent from the parameter coordinating subsection 76 to the storage means 78 and are stored as a database therein.

It should be noted here that even in the case where it has not been judged that the film F is a film cut into pieces, the operator may manually perform retrieval as required. For instance, as described above, in the case of an APS film, the judgment result always shows that the film is not a film cut into pieces, and retrieval is not performed. However, in the case of reprinting of the APS film, it is required to perform retrieval as well. The operator may perform this retrieval manually. Alternatively, in the case where it is known in advance that reprinting is currently being performed, setting may be made so that the retrieval is automatically performed.

In the case where image verification is performed, after the image processing conditions are set in the prescanned image processing section 54, prescanned data is read out from the prescan memory 50 and is subjected to image processing in accordance with the image processing conditions set in the processing subsection 62. Next, the processed data is supplied to the signal converting subsection 64 and is converted into image data that can be displayed on the display 20, and a prescanned image is displayed on the display 20 as a simulation image.

The operator confirms (verifies) the image, that is, a processing result displayed on the display 20 and, as the need arises, makes adjustments of color, density, gradation, and the like using an adjustment key or the like set on the keyboard 18a.

An adjustment signal is transmitted to the key correcting subsection 74. The key correcting subsection 74 calculates correction amounts for the image processing conditions corresponding to the input and sends them to the parameter coordinating subsection 76.

As described above, the parameter coordinating subsection 76 generates image processing conditions for making this correction in accordance with the sent correction amounts, sets the generated image processing conditions at predetermined positions of the two processing subsections, and corrects image processing conditions set in the two processing subsections in advance. Consequently, the image displayed on the display 20 also changes in accordance with the input by the operator.

If the operator judges that the image displayed on the display 20 is appropriate (verification result is OK), the operator gives a command showing this judgment result using the keyboard 18a or the like.

By doing so, image processing conditions are established and then fine scan is started, in this example. That is, reading conditions for fine scan including a stop-down value of the variable diaphragm 24 are set in the scanner 12, the carrier 30 transports the film F at a speed corresponding to fine scan, and the fine scan is started.

It should be noted here that in the case where the verification is not performed, at a point in time when the setting of the image processing conditions in the fine scanned image processing section 56 by the parameter coordinating subsection 76 is finished, the image processing conditions are established and the fine scan is started. It is preferable that whether or not such verifications are to be performed is selectable as a mode.

The fine scan is performed in the same manner as prescan except that there are used the reading conditions for fine scan that include a set stop-down value of the variable diaphragm 24 and the like. The output signal from the image sensor 34 is amplified by the amplifier 36 and converted into a digital signal by the A/D converter 38. The digital signal is processed in the data processing section 46 of the processing apparatus 14 and converted into fine scanned data in the log converter 48, with the fine scanned data being then sent to the fine scan memory 52.

After being sent to the fine scan memory 52, the fine scanned data is read out by the fine scanned image processing section 56 and is subjected to image processing under the image processing conditions established in the processing subsection 66. Next, the fine scanned data is converted into image data for output in the signal converting subsection 68 and outputted to the printer 16, which then produces a print on which the image data is reproduced.

In step 130, in accordance with the establishment of the image processing conditions, the parameter coordinating subsection 76 sends the image processing information and the retrieval information such as image characteristic quantities and an FID corresponding to the image processing information, optionally together with the image information on the processed image or the compressed image sent from the image compressing subsection 72 in association with the image processing information or the retrieval information. The storage means 78 stores these pieces of information.

It should be noted here that the operation of storing the image processing information, the retrieval information and the like in the storage means 78 is not limited to the case of printing with film processing or initial printing. For example, the above process may be performed also in the case where an operator remakes a print or in the case where a customer has a complaint against the image quality in the initial printing and makes a reprinting order by specifying color/density processing or the like.

On the other hand, in the case where it has been judged that the film F is a film cut into pieces as a result of the judgment in step 110, the parameter coordinating subsection 76 judges that reprinting is currently being performed and the processing proceeds to step 140 in which retrieval from the storage means 78 is automatically performed.

That is, in the image compressing subsection 72 and the parameter coordinating subsection 76 of the condition setting section 58 and the storage means 78, retrieval from an image database is performed at the time of reprinting using a prescanned image for reprinting that has been set by the setup subsection 70 of the condition setting section 58.

The method of performing the retrieval is not specially limited. For instance, as a preparation for retrieval, the setup subsection 70 produces image characteristic quantities of a prescanned image for reprinting as the retrieval information in the same manner as printing with film processing, or the image compressing subsection 72 compresses the prescanned data by the same image compressing method as in the case of printing with film processing or by converting the image characteristic quantities of the prescanned image for reprinting thereby producing the compressed image of the frame to be reprinted or the image characteristic quantities-compressed image as the retrieval information. The thus obtained image characteristic quantities, compressed image, and image characteristic quantities-compressed image are sent to the parameter coordinating subsection 76 and used therein to retrieve from the storage means 78 for ranking the compressed images (candidate images) having a high matching degree with respect to the frame to be reprinted.

Hereinafter, a retrieval method that uses this compressed image will be described in more detail.

When the image information of an image for which the retrieval is performed (image to be reprinted) as exemplified by the film type, the film number (FID) or the frame number is already known, the parameter coordinating subsection 76 specifies an area (database) of the storage means 78 to be subjected to the retrieval using these pieces of image information as the auxiliary retrieval information, reads a database for prescanned and compressed images, and reads out all or at least one of the compressed images stored in the specified area of the storage means 78 (database). In this process however, at least a part of the image characteristic quantity data of an image for which the retrieval is to be performed may be used for roughly retrieving at least one compressed image from the storage means 78.

Next, the parameter coordinating subsection 76 integrates data in blocks at point-symmetrical positions within the compressed image read from the storage means 78 (database) and the compressed image in the frame to be reprinted that has been sent from the image compressing subsection 72 after having been compressed therein.

When the film F is captured with the scanner 12, there is a case where an image to be reprinted is rotated and the direction (top and bottom) of the image becomes different from the direction of an image obtained at the time of initial printing, depending on a direction in which the film F is loaded into the scanner 12, that is, whether the smallest frame number is positioned at the leading end of the film or is positioned at the trailing end thereof. In this case, even if compressed images are obtained from the same image, data of the compressed image in the frame to be reprinted becomes completely different from data of the compressed image read from the storage means 78 (concerning its arrangement and the like) and therefore it becomes impossible to perform appropriate retrieval.

In contrast to this, by dividing the images into blocks and integrating the blocks at point-symmetrical positions as described above, it becomes possible to ensure that data of the compressed image in the frame to be reprinted is identical to data of the compressed image read from the storage means 78 irrespective of the film loading direction, which makes it possible to perform precise retrieval with stability.

Next, the retrieval is performed in the manner described below.

First, primary retrieval is performed by comparing characteristic values of DC components (luminance components) of the compressed image in the frame to be reprinted and the compressed image read from the storage means 78 in each integrated block (that is, spatial frequencies of a Y component are compared with each other, in this example) until a predetermined order.

Further, as to images selected as a result of the primary retrieval, AC components (spatial frequencies of Cb and Cr that are chrominance components, in this example) are compared in each integrated block until a predetermined order, and images (candidate images) are ranked (sorted) from the one having a higher matching degree with respect to the compressed image in the frame to be reprinted.

It should be noted here that in place of the primary retrieval and the secondary retrieval, after the primary retrieval is performed, there may be performed two-stage retrieval where the characteristic values of luminance components are retrieved until an order that is higher than the order during the primary retrieval. Alternatively, after the primary retrieval is performed, there may be performed two-stage retrieval where both of retrieval of chrominance components and retrieval of luminance components until the higher order are performed.

For instance, this ranking is exemplified by a method with which there is calculated an absolute value of a difference in characteristic value between the compressed image in the frame to be reprinted and the compressed image read from the storage means 78 in each integrated block, there is calculated a weight with which a difference “0” becomes the maximum value “1”, there is performed the multiplication of the weight in every integrated block, and the ranking is performed so that an image closer to “1” is set as an image having a higher matching degree.

Here, a compressed image judged as having the highest matching degree may be determined as a compressed image (hereinafter referred to as the “target image”) obtained during initial printing that corresponds to the frame to be reprinted. Alternatively, in the case where a multiplication value of a compressed image judged as having the highest matching degree exceeds a threshold value, this image may be determined as the target image. Further, a predetermined number of images may be displayed on the display 20 so that an image ranked at a higher place is positioned closer to the top, and the operator may select one of them as the target image. Alternatively, one of these methods may be selected as appropriate.

It should be noted here that in the case where an image having the highest matching degree does not exceed the threshold value during the determination of the target image using the threshold value or in the case where it is impossible to select the target image from images displayed on the display, there is performed the same processing as in the case of initial printing described above.

Note that in the case where images are displayed on the display 20, the candidate images, out of compressed images read out from the storage means 78, are decompressed in the parameter coordinating subsection 76, with a candidate image having the highest matching degree being decompressed first. That is, inverse DCT conversion is performed on compressed images that are the candidate images (that is, spatial frequencies (DCT output terms)) in order to obtain pixel data of YCC images. Then, matrix conversion that is inverse to YCC conversion is performed on the obtained YCC images, thereby converting the YCC images into RGB images.

Finally, the parameter coordinating subsection 76 supplies image data obtained as a result of this retrieval to the signal converting subsection 64, the supplied image data is converted, and images obtained as a result of the retrieval are displayed on the display 20.

After the target image is selected from the compressed images stored in the storage means 78 in this manner, the parameter coordinating subsection 76 reads out image processing information accompanying the selected target image or associated with the selected target image to be stored from the storage means 78 and sends the information to the setup subsection 70.

The setup subsection 70 sets image processing conditions and the like with reference to the calculated image characteristic quantities, etc. and the image processing information sent from the parameter coordinating subsection 76, and sends the set image processing conditions and the like to the parameter coordinating subsection 76. Note that this image processing is set so that there is basically reproduced image processing performed at the time of initial printing.

The parameter coordinating subsection 76 sets the image processing conditions and the like at a predetermined position of the fine scanned image processing section 56.

For instance, after automatic retrieval is performed with the method described above and image processing conditions used during initial printing are set, the processing proceeds to next step 150 in which there is performed processing for reprinting.

That is, image processing conditions are established as a result of this setting of the image processing conditions in the fine scanned image processing section 56 and then fine scan is started. Alternatively, as required, the image processing conditions may be established by performing verification in the same manner as in the initial printing.

Fine scan is basically performed in the same manner as in the initial printing and the scanner 12 operates as follows under supplied reading conditions for fine scan: The output signal from the image sensor 34 is amplified by the amplifier 36 and is converted into a digital signal by the A/D converter 38. The digital signal is processed in the data processing section 46 of the processing apparatus 14 and is converted into fine scanned data by the log converter 48. The fine scanned data is sent to the fine scan memory 52 and is stored therein.

Next, the fine scanned data is read out from the fine scan memory 52, is processed in the processing subsection 66 under the set processing conditions, and is converted into image data for output in the signal converting subsection 68. The image data for output is outputted to the printer 16, which then outputs a print in which the image data is reproduced.

This image reproduced by the reprinting is basically an image subjected to the same image processing as in the initial printing under the same image processing conditions as in the initial printing, so that there is obtained an image that is suitably identical to an image obtained by the initial printing in color and density.

That is, according to this embodiment, in the case where it has been judged that the film F from which the image is captured by the scanner 12 is a film cut into pieces, it is judged that reprinting is currently being performed and desired image-related information is suitably retrieved from a database or the like in the storage means 78 using a compressed image. In addition, the usage of a compressed image makes it possible to cope with many retrieval targets with a small storage capacity.

Also, with the image processing apparatus of the present invention, it becomes possible to appropriately read out image processing information used at the time of initial printing by the retrieval method described above and to reproduce image processing performed at the time of initial printing, which makes it possible to ensure that an image on a reprint is identical to an image on a print made on the occasion of film processing or an initial print. Accordingly, even in the case where a film has no unique ID number and is divided into pieces after initial printing like in the case of a 135-size film, it becomes possible to ensure with stability that an image on a reprint is identical to an image on a print made on the occasion of film processing or an initial print.

In the example described above, as the retrieval system and image processing apparatus of the present invention, there has been described a system and apparatus where the parameter coordinating subsection 76 compresses a prescanned image in the image compressing subsection 72, an obtained compressed image of the prescanned image is stored in the storage means 78 as a database so that the compressed image is associated with image processing information such as image processing conditions concerning this compressed image, the compressed image stored in the storage means 78 is retrieved as it is, and the image processing information concerning the compressed image obtained as a result of retrieval is read out and used as reading conditions for a fine scanned image or image processing conditions. However, the present invention is not limited to this. That is, there occurs no problem even if the image compressing subsection 72 is not provided. In this case, a compressed image of a prescanned image separately created at the outside is stored in the storage means 78 and the stored compressed image is retrieved as it is. Also, there occurs no problem even if image processing information concerning the compressed image is not stored under a state where the image processing information is associated with the compressed image. In this case, only the compressed mage is retrieved.

Also, in the example described above, a prescanned image (data) is compressed to generate a compressed image (data). However, the present invention is not limited to this and a fine scanned image (data) may be compressed to generate the compressed image.

It should be noted here that the retrieval is not limited to the aforementioned retrieval (image retrieval) using the compressed image as described above. In the case of a 135 film or a Brownie film for example, as described above, there may be performed retrieval (image retrieval) using not only the compressed image but also an image. Retrieval using image characteristic quantities (data only) may also be preferably performed. Also, in the case of an APS film, retrieval can be performed preferably using its FID and a frame number in addition to the image, compressed image or image characteristic quantities.

When consideration is given to the attainment of a processing speed and a storage capacity of the storage means 78 required for retrieval, the retrieval using image characteristic quantity data, an FID and a frame number is more preferable than the image retrieval using an image and a compressed image (data), because the image characteristic quantity data, FID and frame number are merely numeric values. It should be noted here that in the case where the compressed images are stored in the database (storage means) when performing such retrieval, the retrieved compressed images can be displayed on the display and used for confirming the retrieval result. The compressed image of the image to be processed is preferably used for retrieval or confirmation of the retrieval result, but in order to confirm the image to be reprinted, that is, the image for a finished print, the compressed image of the processed image is preferably used.

The image processing method and apparatus of the present invention have been described in detail above with reference to various embodiments, but the present invention is not limited to these embodiments. That is, needless to say, it is possible to make various kinds of modifications and changes without departing from the gist of the present invention.

As has been described above, according to the present invention, it is judged whether retrieval should be performed depending on whether or not a film from which a image is captured with a scanner is a film cut into pieces and optionally whether or not setting has been made for selecting the retrieval, and the retrieval is thus automatically carried out when the film is loaded on a carrier, so that it becomes possible to automatically perform the retrieval without performing key manipulation, which enables improvement of the processing efficiency and simplified processing.

What is claimed is:

1. An image processing apparatus comprising:
image inputting means which photoelectrically captures an image photographed on a film to input an input image;
image processing means which subjects said input image inputted by said image inputting means to image processing to obtain a processed image;
storage means which stores image processing information concerning said image processing performed on said input image by said image processing means and retrieval information for specifying said input image in association with each other;
retrieval means which performs retrieval from said storage means using said retrieval information concerning said input image in accordance with a command that specifies reprocessing of said input image; and
film judging means which judges whether or not the image-captured film from which said image is captured by said image inputting means is a cut film cut into pieces,
wherein, when said film judging means judges that said image-captured film is the cut film, said retrieval means performs the retrieval automatically from said storage means, and wherein said image processing means performs the reprocessing on said input image to which the command for specifying the reprocessing is given, using at least said image processing information retrieved by said retrieval means.

2. The image processing apparatus according to claim 1, wherein said storage means further stores at least one of image information concerning said input image processed by said image inputting means, a compressed image of said input image, and a compressed image of said processed image in association with said image processing information or said retrieval information, and wherein said retrieval means retrieves at least said image processing information from said storage means using at least one of image characteristic quantities of said input image, said image information, the compressed image of said input image and the compressed image of said processed image as said retrieval information.

3. The image processing apparatus according to claim 1, wherein, when said film judging means judges that said image-captured film is the cut film, said retrieval means automatically retrieves at least said image processing information from said storage means.

4. The image processing apparatus according to claim 1, wherein said retrieval means is provided with a mode in which the retrieval is not performed if said film judging means judges that said image-captured film is not the cut film.

5. The image processing apparatus according to claim 1, wherein said retrieval means is provided with an automatic retrieval mode which is previously selectable and in which the retrieval from said storage means is automatically performed even if said film judging means judges that said image-captured film is not the cut film.

6. The image processing apparatus according to claim 5, wherein said automatic retrieval mode which is previously selectable is set in accordance with at least one of a type and a form of said film, wherein said film judging means can also judge whether or not said image-captured film is a previously set film, and wherein if said film judging means judges that said image-captured film is the previously set film, said retrieval means turns to the automatic retrieval mode to automatically retrieve from said storage means.

7. An image processing method with which an image photographed on a film is photoelectrically captured to input an input image, which is then processed to obtain a processed image, comprising the steps of:
storing image processing information concerning processing performed on the input image and retrieval information for specifying said input image in association with each other;
judging whether or not the image-captured film is a cut film cut into pieces;
automatically performing retrieval from said storage means using said retrieval information concerning said input image in accordance with a command specifying reprocessing of said input image when said image-captured film is judged as the cut film; and
performing said reprocessing on the input image whose reprocessing has been commanded, using said image processing information concerning said input image whose reprocessing has been commanded.

8. The image processing method according to claim 7, wherein said storage means further stores at least one of image information concerning said input image processed by said image inputting means, a compressed image of said input image, and a compressed image of said processed image in association with said image processing information or said retrieval information, and wherein at least said image processing information is retrieved from said storage means using at least one of image characteristic quantities of said input image, said image information, the compressed image of said input image and the compressed image of said processed image.

9. The image processing method according to claim 7, wherein, when said image-captured film is judged as the cut film, at least said image processing information is automatically retrieved.

10. The image processing method according to claim 7, wherein when said image-captured film is not judged as the cut film, said retrieval is not performed.

11. The image processing method according to claim 7, wherein even in the case where said image-captured film is not judged as the cut film, said retrieval is automatically performed when previous selection is made for automatic retrieval.

12. The image processing method according to claim 11, wherein said previous selection is made in accordance with at least one of a type and a form of said film and if said image-captured film is judged as a previously set film, said automatic retrieval is performed.
